(19) United States
(12) Patent Application Publication
(10) Pub. No.: US 2010/0208773 A1
(43) Pub. Date: Aug. 19, 2010

(54) Auto-Calibration Filtering Device

(75) Inventors: Remi Corbiere, Elancourt (FR); Vincent Petit, Bazainville (FR); Bruno Louis, St Maur (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Thales, Neuilly-sur-Seine (FR)

(21) Appl. No.: 12/640,277

(22) Filed: Dec. 17, 2009

(30) Foreign Application Priority Data
Dec. 19, 2008 (FR) 08/07235

(51) Int. Cl. H04B 1/707; H04B 1/10

(52) U.S. Cl. 375/147; 327/552; 375/E01.002

(57) ABSTRACT

A filtering device based on an active transconductance filter includes auto-calibration means, the principle of calibration consisting in slaving the power supply current for the filter as a function of the phase shift between a second signal shifted by a first predetermined phase shift with respect to a periodic reference signal, and the output signal of the filter in response to a first signal shifted by a second predetermined phase shift with respect to the periodic reference signal, the slaving tending to minimize the phase shift between the output signal of the filter and the second signal.

### CROSS-REFERENCE TO RELATED APPLICATIONS

This application claims priority of foreign French patent application no. FR 0807235, filed Dec. 19, 2008, the disclosure of which is hereby incorporated by reference in its entirety.

### BACKGROUND OF THE INVENTION

1. Field of the invention

The present invention relates to an auto-calibration filtering device. It applies for example to the field of the integrated circuits with which satellite geo-positioning reception devices are equipped.

2. Discussion on the background

Filters are fundamental elements of electronic circuits. They make it possible notably to process an input signal so as to discriminate undesirable signals therefrom, or else to isolate particular frequency bands thereof. In particular, filters are widely used in telecommunications devices, as well as in radars, and notably in the reception chains of satellite geo-positioning devices, or GPS, the acronym standing for Global Positioning System.

Passive filters, that is to say operating without any power supply source of their own, are produced with the aid of passive components such as resistors, coils and capacitors. The selectivity of a filter is all the higher the larger the number of components; however, numerous applications, notably in the field of telecommunications, require a large number of filters exhibiting high selectivity. Numerous applications furthermore require that the electronic circuits be integratable into a minimum bulk. However, passive filters lend themselves poorly to extreme miniaturization, the use of passive components, notably of coils and of capacitors of large capacitance, being incompatible with integration into electronic chips, fabricated according to techniques of monolithic microwave integrated circuit or MMIC type, or else of application specific integrated circuit or ASIC type.

Active filters comprise amplifying elements and can exhibit power gains higher than one. Such filters make it possible, by virtue of the use of active components such as operational amplifiers or else of transconductance amplifiers, to synthesize the characteristics of filters usually produced with resistors, capacitors and coils. They exhibit the advantage of being more easily integratable, since they can do away with coils which are expensive, difficult to integrate and imperfect, in the sense that they exhibit significant stray resistances and capacitances that are difficult to control, as well as high sensitivity to external electromagnetic fields.

Certain active filters are produced with the aid of active cells using transistor transconductance allied with a capacitance of reasonable value, therefore easily integratable. Although the performance of these filters is very good, these filters are very sensitive to variations in the fabrication process, as well as to variations in their supply voltage and in their operating temperature.

Capacitors exhibit capacitances which are sensitive to the fabrication process, consequently the absolute values of the capacitances of integrated capacitors vary greatly about their nominal value, of the order of ±30% for integrated capacitors using for example CMOS technology. Nevertheless the match between two capacitances of the same value within one and the same chip is very satisfactory, with a ratio of capacitances of the order of 0.2%. It is therefore possible to circumvent the wide tolerance ranges related to the absolute values of the capacitances, with designs of circuits involving in the calculation of the performance of the filter, not isolated capacitances but ratios between capacitances.

In the same manner, the supply voltages are readily controllable.

On the other hand the transconductance, which is just as determining for the performance of active filters, is dependent on the current flowing in the filter, as well as on the temperature; the current being itself dependent on the fabrication process and on the filter supply voltage. Consequently, the calibration of these filters requires the consideration of all these parameters, and produces a performance spread which is inappropriate from a practical point of view.

There exist certain solutions consisting in carrying out an adjustment of the performance of the filters on completion of their fabrication process, for example by laser etching so as to finely adjust the values of the resistances, or else by fusing. There exist other solutions consisting in calibrating the filters from the external by switching current sources. These existing solutions make it possible to limit the performance spread, but exhibit the drawback of requiring the intervention of an outside user. There exist yet other solutions using PLL-based systems, the acronym standing for “phase-locked loop”, but such solutions render the design of the circuits more complex, and integrate extra functions which increase the surface area of the chips, and add extra drifts.

### SUMMARY OF THE INVENTION

One purpose of the invention is to alleviate the abovementioned problems, by proposing a device making it possible to undertake the calibration of an active filter integrated onto a chip, in an autonomous manner not requiring the intervention of a person or of an outside device. A device according to the invention exhibits the advantage of being able to be easily integrated into various transmitter/receiver architectures. Another advantage of the device according to the invention is that it exhibits performance which is independent of the spread in the fabrication method from which it arises.

The present invention proposes to make the current follow a law proportional to temperature, so as to render the transconductance of the filter constant whatever the operating temperature, and then to undertake a calibration of the filter for example each time the circuit is turned on, without requiring any third-party intervention. This solution is based on the relationship between the state of the phase of a signal traversing the filter, and the frequency of this signal. Once the filter has been dimensioned, its parameters can be extracted so as to ascertain the state of the phase at a given frequency. A frequency reference, generally available in any system integrating a filtering device, makes it possible to carry out the calibration of the filter, according to the following principle: the frequency reference is used to generate a reference signal, compatible with the frequency band of the filter, which passes at one and the same time through the filter and to the outside of the filter. The phase offset between the resulting signal at the output of the filter and the reference signal is determined and makes it possible to control the adjustment of the current of the active filter until a measured phase offset corresponding to the expected performance of the filter is obtained.

For this purpose, the subject of the invention is a filtering device comprising an active transconductance filter, said filtering device comprising calibration means comprising comparison means for comparing the phase of the output signal of the filter in response to a first periodic signal, with the phase of a second periodic signal of the same frequency as the first signal, phase-shifted from the first signal by a predetermined phase shift, the comparison means being able to slave a current-control device controlling the power supply of the active filter so as to minimize the difference between the phase of the output signal of the filter in response to the first signal, and the phase of the second signal.

In one embodiment of the invention, the filtering device described above can furthermore comprise a polyphase filter able to generate on the basis of a reference signal, the said first signal phase-shifted by a first determined phase shift φ1 with respect to the reference signal and the said second signal phase-shifted by a second determined phase shift φ2 with respect to the reference signal, the difference between φ2 and φ1 being equal to the nominal output phase shift of the filter in response to a signal whose frequency is equal to the frequency of the periodic reference signal.

In one embodiment of the invention, the filtering device described above can be characterized in that the signals have an amplitude exhibiting two logic levels, the phase comparison means comprising a D flip-flop the clock input of which is driven by the second signal, and the D input by the output signal of the active filter and to offer as output a given logic level if the output signal of the filter leads with respect to the second signal or the other logic level if the output signal of the filter lags behind the second signal.

In one embodiment of the invention, the filtering device described above can be characterized in that the signals have an amplitude exhibiting two logic levels, the phase comparison means comprising a D flip-flop the D input of which is driven by the second signal, and the clock input by the output signal of the active filter and to offer as output a given logic level if the output signal of the filter leads with respect to the second signal or the other logic level if the output signal of the filter lags behind the second signal.

In one embodiment of the invention, the filtering device described above can be characterized in that the current-control device controlling the power supply for the active filter is able to increment the current by a predetermined notch when the output of the D flip-flop is at a given logic level, or decrement it by a predetermined notch when the output of the D flip-flop is at the other logic level, the incrementation and the decrementation of the current being done by successive iterations synchronized by the output of the D flip-flop, until a predetermined number of successive output states of the D flip-flop corresponds to a predetermined sequence.

The subject of the invention is further a satellite geo-positioning signal reception device comprising a filtering device such as described above.

In one embodiment, the satellite geo-positioning signal reception device can be characterized in that the calibration means are activated each time the signal reception device is put into service, by means of a signal activated during power-up.

### BRIEF DESCRIPTION OF THE DRAWINGS

Other characteristics and advantages of the invention will become apparent on reading the description, given by way of example and in conjunction with the appended drawings which represent:

FIG. 1, the schematic of an exemplary auto-calibration filtering device according to the invention,

FIG. 2, the schematic of an exemplary auto-calibration filtering device according to the invention, describing in detail the operating principle of the D flip-flop and of the current-control device,

FIG. 3, the curves representing the operation of an exemplary phase comparison device forming part of the filtering device according to the invention,

FIG. 4, the flowchart representative of an exemplary implementation of an auto-calibration sequence of an active filter according to the invention.

### DESCRIPTION OF THE PREFERRED EMBODIMENTS

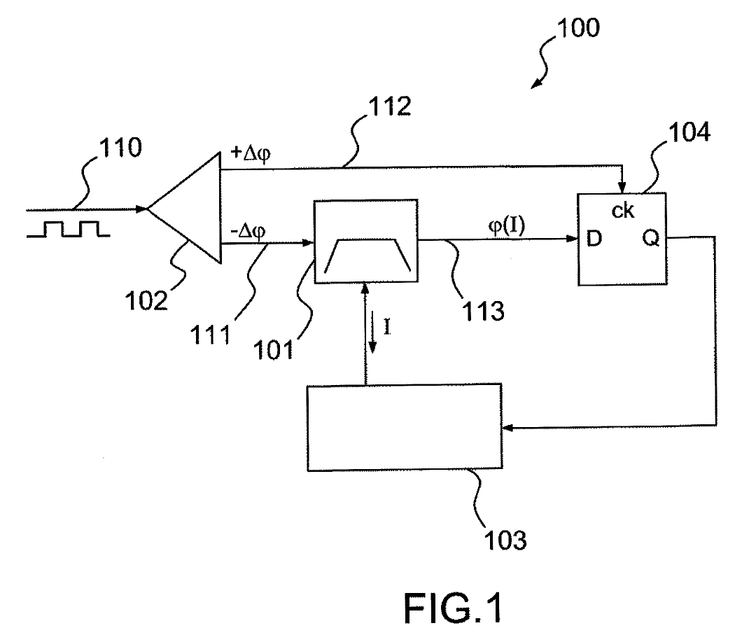

FIG. 1 presents the schematic of an exemplary system 100 according to the invention comprising an auto-calibration filter 101. The system comprises a polyphaser 102 receiving as input a reference signal 110, and producing as output a first signal 111 shifted with respect to the reference signal 110 by a first determined phase shift φ₁, and a second signal 112 shifted with respect to the reference signal 110 by a second predetermined phase shift φ₂. The reference signal 110 can for example be a signal of sinusoidal shape or, in the example illustrated by the figure, a signal whose amplitude exhibits two logic levels. The system furthermore comprises a D flip-flop 104, and a device for controlling the current 103 for controlling the filter 101. The filter 101 is an active filter constructed on the basis of transconductance transistors, its characteristics can be adjusted as a function of the power supply current for this filter. The filter 101 produces in response to the first signal 111, an output signal 113. The second signal 112 does not enter the filter 101: its phase is compared with the phase of the signal 113 exiting the filter 101. In the example presented, the D flip-flop 104 makes it possible to compare the phase of the signal 113 exiting the filter 101 with the phase of the second signal 112: the filter output signal 113 is applied to the input of the D flip-flop 104, whose clock input is driven by the second signal 112, thus the output of the D flip-flop 104 exhibits at output a logic level 1 if the phase of the filter output signal 113 leads that of the second signal 112, or a logic level 0 in the converse case. Of course the D flip-flop can provide reciprocal output states if its clock input is driven by the filter output signal 113, and its D input by the second signal 112. If the polyphaser 102 is constructed so as to produce a phase shift between the first signal 111 and the second signal 112, corresponding to the opposite of the nominal phase shift produced by the filter 101 in response to a periodic signal of given frequency, it may be considered that the filter 101 is correctly centred if the phase shift between the signal 113 at the filter output, and the second signal 112 is zero. In the example of the figure, the first signal 111 is phase-shifted from the reference signal 110 by φ₁ to −Δφ, and the second signal 112 is phase-shifted from the reference signal 110 by φ₂ equal to +Δφ, the nominal phase shift generated by the filter 101 in response to a signal whose period equals the period of the periodic signal 110 being 2Δφ. In this way, a slaving of the filter is carried out, by a device 103 for controlling the power supply current for the filter 101 as a function of the state of the output of the D flip-flop 104, by successive iterations so as to minimize the phase shift between the output signal 113 of the filter 101 and the second signal 112. The current-control device can notably comprise a shift register, not represented in this figure, but described in detail hereinafter with reference to the following figures. The current-control device 103 is itself supplied by a current source, not represented, which produces a current which follows a law inversely proportional to temperature, so as to counterbalance the effects of temperature on the transconductance value of the transistors. Such current sources are in themselves known to those skilled in the art, by the acronym PTAT standing for Proportional To Absolute Temperature. The frequency of the reference signal 110 is chosen so as to be included in the passband of the filter 101. For example, in the case of a GPS receiver, the reference signal 110 can be obtained from a clock signal existing in the circuit, via known frequency division devices.

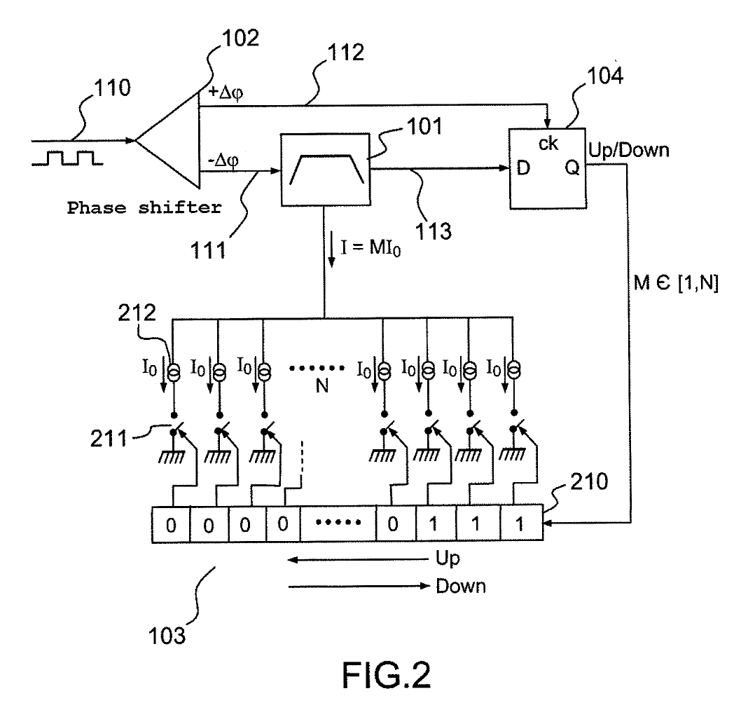

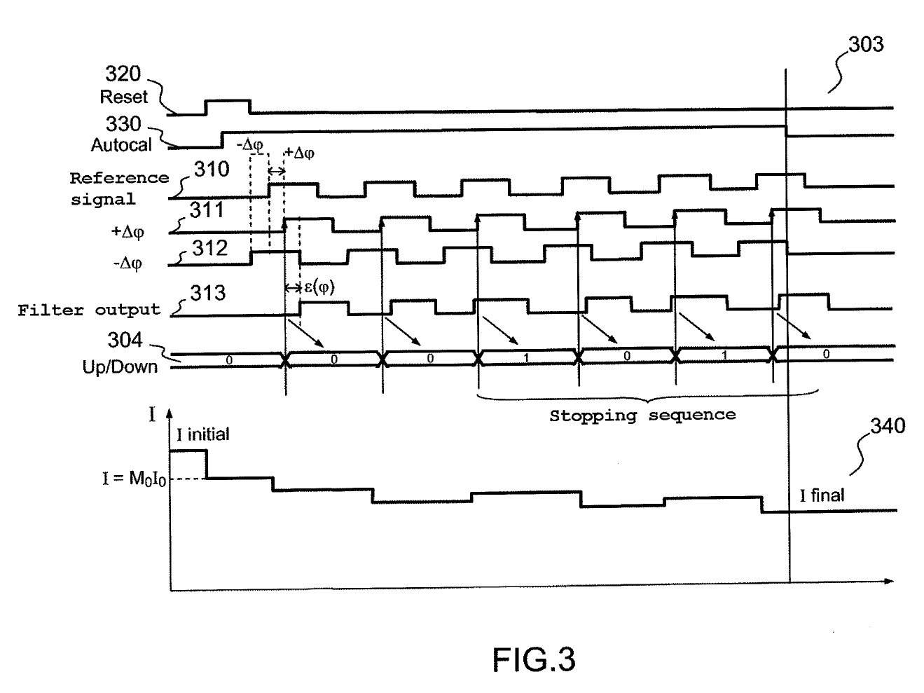

FIG. 2 presents the schematic of an exemplary auto-calibration filtering device according to the invention, describing in detail the operating principle of the D flip-flop 104 and of the current-control device 103. A shift register 210 comprises a plurality N of bits forming a word M, each bit being connected to N switches 211 each controlling a current source 212 providing a current I₀. The branches comprising a current source 212 and a switch 211 are connected in parallel, and supply power to the filter 101 through a current I equal to the sum of the currents that they produce. The operation of the D flip-flop 104 is explained in detail hereinafter, with reference to FIG. 3. The filter 101 is controlled by the current I. In the example of the figure, a rising edge of the active output or “UP” of the D flip-flop 104 causes a shift of the register 210 to the left, and thus the decrementation of the supply current I powering the filter 101 by a notch I₀. Reciprocally, a falling edge or “DOWN” of the D flip-flop 104 causes a shift of the register 210 to the right, and thus the incrementation of the supply current I powering the filter 101 by a notch I₀. Of course the device according to the invention can operate in a similar manner if a rising edge of the active output of the D flip-flop 104 causes a shift of the register 210 to the right, therefore an incrementation of the supply current I powering the filter 101 by a notch I₀, and if a falling edge of the active output of the D flip-flop 104 causes a shift of the register 210 to the left, therefore a decrementation of the supply current I powering the filter 101 by a notch I₀.

FIG. 3 presents a timechart 303 representing the output state 304 of the D flip-flop 104 as a function of the output signal 113 of the filter 101 applied as input to the flip-flop and represented as a function of time by a curve 313, and of the second signal 112 operating it, represented as a function of time by a curve 312. A curve 311 is representative of the first signal 111 applied as input to the filter 101 as a function of time. A curve 310 represents the reference signal 110 as a function of time. A curve 320 represents a signal controlling the reinitialization of a device comprising the auto-calibration filtering device according to the invention, as a function of time. A curve 330 represents a control signal of the auto-calibration process implemented by the device according to the invention, as a function of time. A curve 340 represents the value of the supply current I powering the filter 101 as a function of time. The signal 111 applied as input to the filter 101, and therefore the reference signal 110, exhibit an amplitude which is consistent with the filter 101 to be calibrated; in the example of the figure, these signals are represented by logic levels, for the sake of clarity.

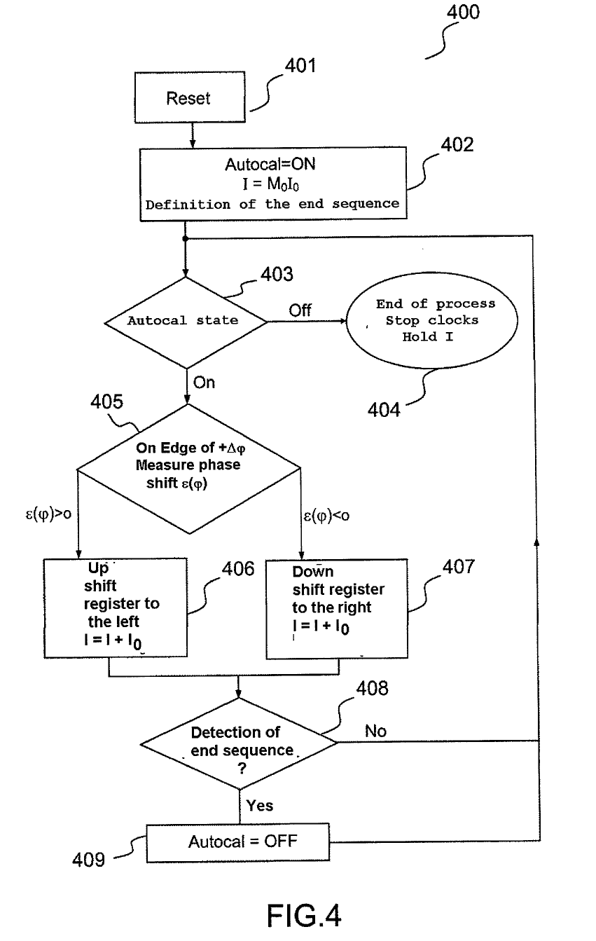

Upon reinitialization of the apparatus comprising the filtering device according to the invention, for example during its power-up, the auto-calibration procedure is engaged; at this moment, the output of the D flip-flop 104 is at 0. For greater clarity, the course of the procedure is explained by the description of a flowchart 400 hereinafter, with reference to FIG. 4. As indicated by the curve 312, the second signal 112 is shifted in time by a phase shift +Δφ with respect to the reference signal 110. As indicated by the curve 311, the first signal 111 applied as filter input is shifted by a phase shift −Δφ with respect to the reference signal 110. As indicated by the curve 340, the supply current I powering the filter 101 before the engaging of the auto-calibration procedure has a value which is dependent on the fabrication process of the integrated circuit, on the supply voltage and on the temperature. As soon as the auto-calibration procedure is started, the current I takes a value M₀*I₀, the word M₀ being predetermined, and defined by the shift register 210. Hereinafter, each rising edge of the second signal 112 represented by the curve 312 will be dubbed an iteration.

At the first iteration, the signal 113 exiting the filter, as indicated on the curve 313, is shifted from the second signal 112 by a phase shift ε(φ). The aim of the successive iterations is to minimize the value of ε(φ). The D flip-flop 104, synchronized with the iteration, therefore restores the value 0 taken by the filter output signal 113 before the iteration. Consequently, the shift register 210 is shifted to the right, and the supply current I powering the filter 101 is decremented by a value I₀.

At the second iteration, the output signal 113 of the filter 101 still exhibits a lag with respect to the second signal 112, i.e. a positive value of ε(φ). Consequently, the output of the D flip-flop 104 is still at 0, and the supply current I powering the filter 101 is again decremented by a notch

At the third iteration, the output signal 113 of the filter 101 now exhibits a lead with respect to the second signal 112, i.e. a negative value of ε(φ). Consequently, the output of the D flip-flop 104 switches to 1, and the supply current I powering the filter 101 is incremented by a notch I₀.

At the fourth iteration, the output signal 113 of the filter 101 again exhibits a lag with respect to the second signal 112, i.e. a positive value of ε(φ). Consequently, the output of the D flip-flop 104 switches back to 0, and the supply current I powering the filter 101 is again decremented by a notch I₀.

At the fifth iteration, the output signal 113 of the filter 101 exhibits a lead with respect to the second signal 112, i.e. a negative value of ε(φ). Consequently, the output of the D flip-flop 104 again switches to 1, and the supply current I powering the filter 101 is again incremented by a notch I₀.

At the sixth iteration, the output signal 113 of the filter 101 again exhibits a lag with respect to the second signal 112, i.e. a positive value of ε(φ). Consequently, the output of the D flip-flop 104 switches back to 0, and the supply current I powering the filter 101 is again decremented by a notch I₀.

A sequence for stopping the auto-calibration procedure can for example be defined by the succession of the values 1-0-1-0 at the output of the D flip-flop 104, thus in the example of the figure, the procedure can terminate at this juncture.

FIG. 4 presents a flowchart 400 representing an exemplary auto-calibration sequence for the filtering device according to the invention. The calibration sequence is for example run each time the system comprising the filtering device according to the invention is put into service.

A first step 401 corresponds to the turning on of the device integrating an auto-calibration filtering device according to the invention, for example a GPS receiver.

A following step 402 starts the auto-calibration process, by the switching to 1 of the procedure control bit, dubbed Autocal. At this step, it is recalled that the power supply current for the filter 101 is equal to M₀*I₀. Furthermore, during this step, the end-of-procedure sequence is defined. Advantageously, the end sequence is predefined once and for all by the manufacturer of the device.

During a step 403, the value of the Autocal bit is checked. If it is zero, then the auto-calibration procedure ends, and the last value of the supply current I powering the filter 101, determined by the successive iterations, is preserved until a subsequent auto-calibration procedure, for example until the next time the GPS receiver is put into service. If the value of the Autocal bit is 1, then we go to a next step 405.

During step 405, the sign of the phase shift ε(φ) between the second signal 112 and the output signal 113 of the filter 101 is estimated, via the D flip-flop 104, as explained above with reference to FIG. 3. If the phase shift ε(φ) is positive, we go to a next step 406, where the supply current I powering the filter 101 is incremented by a value I₀ as explained above with reference to FIGS. 2 and 3; if the phase shift ε(φ) is negative, we go to a next step 407, where the supply current I powering the filter 101 is decremented by a value I₀ as explained above with reference to FIGS. 2 and 3.

A following step 408 consists in detecting the end-of-procedure sequence such as defined in step 402, and then the auto-calibration procedure resumes its course in step 403.

What is claimed is:

1. A filtering device comprising an active transconductance filter, said filtering device comprising calibration means comprising comparison means for comparing the phase of the output signal of the filter in response to a first periodic signal, with the phase of a second periodic signal of the same frequency as the first signal, phase-shifted from the first signal by a predetermined phase shift, the comparison means being able to slave a current-control device controlling the power supply of the active filter so as to minimize the difference between the phase of the output signal of the filter in response to the first signal, and the phase of the second signal.

2. The filtering device according to claim 1, further comprising a polyphase filter able to generate on the basis of a reference signal, the said first signal phase-shifted by a first determined phase shift φ₁ with respect to the reference signal and the said second signal phase-shifted by a second determined phase shift φ₂ with respect to the reference signal, the difference between φ₂ and φ₁ being equal to the nominal output phase shift of the filter in response to a signal whose frequency is equal to the frequency of the periodic reference signal.

3. The filtering device according to claim 2, wherein said signals have an amplitude exhibiting two logic levels, the phase comparison means comprising a D flip-flop the clock input of which is driven by the second signal, and the D input by the output signal of the active filter and to offer as output a given logic level if the output signal of the filter leads with respect to the second signal or the other logic level if the output signal of the filter lags behind the second signal.

4. The filtering device according to claim 2, wherein said signals have an amplitude exhibiting two logic levels, the phase comparison means comprising a D flip-flop the D input of which is driven by the second signal, and the clock input by the output signal of the active filter and to offer as output a given logic level if the output signal of the filter leads with respect to the second signal or the other logic level if the output signal of the filter lags behind the second signal.

5. The filtering device according to claim 3, wherein the current-control device controlling the power supply for the active filter is able to increment the current by a predetermined notch when the output of the D flip-flop is at a given logic level, or decrement it by a predetermined notch when the output of the D flip-flop is at the other logic level, the incrementation and the decrementation of the current being done by successive iterations synchronized by the output of the D flip-flop, until a predetermined number of successive output states of the D flip-flop corresponds to a predetermined sequence.

6. The filtering device according to claim 4, wherein the current-control device controlling the power supply for the active filter is able to increment the current by a predetermined notch when the output of the D flip-flop is at a given logic level, or decrement it by a predetermined notch when the output of the D flip-flop is at the other logic level, the incrementation and the decrementation of the current being done by successive iterations synchronized by the output of the D flip-flop, until a predetermined number of successive output states of the D flip-flop corresponds to a predetermined sequence.

7. A satellite geo-positioning signal reception device comprising a filtering device according to claim 1.

8. The satellite geo-positioning signal reception device according to claim 7, wherein the calibration means are activated each time the signal reception device is put into service, by means of a signal activated during power-up.
